(19) United States
(12) Patent Application Publication
(10) Pub. No.: US 2003/0150306 A1
(43) Pub. Date: Aug. 14, 2003

(54) Apparatus for the automatically cutting of elements made of elastomeric material

(76) Inventors: Adamo Sala, Agrate Brianza (IT); Angelo Tiengo, Osnago (IT)

Correspondence Address: FINNEGAN, HENDERSON, FARABOW, GARRETT & DUNNER, LLP, 1300 I STREET, NW, WASHINGTON, DC, 20005, US

(21) Appl. No.: 10/275,248

(22) PCT Filed: Apr. 19, 2001
(86) PCT No.: PCT/EP01/04437

(30) Foreign Application Priority Data
May 19, 2000 (EP) 00110770.5

(51) Int. Cl. B26D 7/00

(52) U.S. Cl. 83/171; 83/401

(57) ABSTRACT

The present invention relates to an apparatus for the automatic cutting of an element (50) made of elastomeric material, comprising: a rotary blade (11) having a continuous and curvilinear cutting profile, at least one cooling unit for cooling (16) said blade, a supporting structure (12) for supporting said blade, a feed device (14) for moving said supporting structure transversely relative to said element, a motor unit (15) for spinning said blade, and at least one structure (51) for supporting and feeding said element (50) to said blade. In accordance with the present invention, the ratio of the speed of rotation of said blade to the traversing speed of said feed device is between 10 and 40. Furthermore, said cooling unit (10) conveys cold air at least onto a radially outer portion of said blade, and at least one cutting surface on said blade, interacting, during the cut, with said element (50) of elastomeric material has non-stick properties.

The present invention relates to an apparatus for the automatic cutting of elements made of elastomeric material, in particular of elastomeric elements used in the manufacture of a tyre.

More particularly, the present invention relates to a cutting apparatus of the type with a rotary blade which, by an appropriate combination of the blade's speed of rotation and its traversing speed, produces a fast, high-quality cut through said elements.

Still more particularly, the present invention relates to a cutting apparatus provided with a rotary blade which, with appropriate cooling and with nonstick properties, as shown in greater detail in the following of the present description, does not produce off-cuts and is able to generate uniform, regular surfaces without discontinuities, at the ends of said elements.

During the manufacturing process of a tyre, the various semifinished components made of elastomeric material which go to make up the finished tyre are fed, according to a specific sequence of operating steps, to a tyre manufacturing machine that generally includes at least one manufacturing drum on which the above elastomeric elements are progressively positioned and assembled together.

How said drums and the manufacturing machine as a whole function will not be described here as they are not relevant for the purposes of the present invention, for which any tyre manufacturing machine of the prior art can be considered.

In the aforesaid tyre manufacturing process, much use is made both of purely elastomeric elements, consisting in other words of compound alone, and of reinforced elastomeric elements—containing, that is, reinforcing elements such as textile or metallic cords. These elements are preferably prepared in the form of sheets, ribbons or strips of limited and uniform thickness, or of shims or filler blocks whose thickness is greater and varies axially from one edge to the other in the plane of the cross right section through the shim or filler block.

Semifinished products of elastomeric material comprising a reinforcing structure and used in the manufacture of a tyre are, for example, the carcass plies, the belt strips or the reinforcing edges containing textile or metallic cords.

Semifinished products made of elastomeric material only, on the other hand, are for example the sidewalls, the tread band and the air-impermeable layer, technically known as the liner, which covers the inside of the carcass of a tubeless tyre, that is to say a tyre with no inner tube.

The liner is usually attached to a sheet of limited thickness that is similarly made of elastomeric material only and whose function is to promote adhesion between the liner and the carcass ply which is subsequently laid on said sheet during assembly on the drum. This sheet is usually attached to the liner prior to the process of manufacturing the tyre on the drum and often also the resulting semifinished product is pre-assembled with the carcass fabric: the complete pack is then cut to size during the above-mentioned manufacturing process.

Other elements made entirely of elastomeric material and used in the production of tyres, especially giant tyres, that is those intended for heavy goods vehicles and the like, are the so-called underbelt fillers consisting of a strip of elastomeric material, of rather large thickness and basically triangular cross right section, which in use are positioned between the carcass ply and the edges of the belt pack.

Said semifinished products, which, once installed, constitute elements of the tyre required to perform specific distinct functions depending on their position in the tyre, are generally produced from compounds having very different compositions and, as stated, have geometrical dimensions, in particular thicknesses, that are also very different.

All the elastomeric elements mentioned above are unwound from different feed reels or, alternatively, are produced immediately upstream of the tyre manufacturing machine and fed onto said drum where manual or automatic positioning takes place of a first end of the semifinished product or of its first ends in the case of simultaneous unwinding of two or more semifinished products, such as the two sidewalls or underbelt fillers.

Once said first end is positioned on the cylindrical surface of the manufacturing drum, the drum is turned so that the semifinished product is partially wound around its cylindrical surface.

At the end of said rotation the semifinished product is cut to size and its second end, produced by this cutting operation, is joined to the first end previously secured to the surface of the drum.

In the past, and in some cases still today, the cutting operation was done manually by an operator who, having completed the partial rotation of the drum, cut into the edge of the semifinished product (generally a carcass ply or a belt strip) with a suitable cutting instrument such as a knife with a hot blade or a shear, and drew said cutting instrument through the semifinished product to separate the portion wound on the drum from the upstream portion.

In the case of semifinished products consisting of compound only, the cut is normally executed by a rotary-blade cutter which is driven transversely across the semifinished product.

This cut, especially when done by hand, has numerous drawbacks, the first of which is the inevitable irregularity and lack of uniformity of the cut surface, with deterioration of the tapering portions of the semifinished product and crushing of the edges of its cross right section; these disadvantages are subsequently translated into the difficulty of preparing a good joint on the drum between said first and second ends of the semifinished product.

Moreover, if the elastomeric material has been cut slightly short, the operator is inevitably forced to remedy this fact by pulling manually on the elastomeric material and so introducing undesired stretching into the material.

If on the other hand the cut has been made too generously, the operator is forced to overlap the ends to an excessive degree, thus causing a discontinuity which has a deleterious effect on the quality of the tyre manufacturing operation, as well as on the behaviour of the finished tyre.

Furthermore, a cutting operation performed manually by the operator takes up a lot of time which has negative repercussions on the overall productivity of the manufacturing process.

These drawbacks have therefore, as observed, led to the devising of highly automated manufacturing processes and to the use of automatic-type cutting appliances.

Many different types of appliance for the automatic cutting of elastomeric elements are known in the art.

EP-714,750 discloses an appliance comprising an electrically heated fixed blade (knife) which is moved transversely across the strip of elastomeric material to be cut.

A different method for the automatic cutting of elastomeric materials with devices of the knife type, however, uses a vibrating blade such as that disclosed in patents GB-2,178,686 and EP-324,199.

Said blade has the peculiarity of being made to vibrate with an oscillatory movement in a vertical direction at a high frequency such as, for example, an ultrasonic frequency.

Other cutting appliances designed to operate not only on elastomeric material but also on strips of elastomeric material containing a reinforcing structure, such as the usual rubber-coated fabrics incorporating a plurality of textile or metallic cords which are used in the manufacture of a tyre, employ a rotary blade moved transversely across said strips and said cords. Examples of rotary blade-type cutting appliances are disclosed in patents U.S. Pat. No. 5,887,506, EP-284,761, EP-250,972, U.S. Pat. No. 4,722,255.

All these appliances normally include a supporting structure to which the cutting device (the abovementioned knife or the abovementioned rotary blade) is fixed via an intermediate slide which travels on suitable guides and which, during the cutting operation, as the function of operating said device from one side to the other of the strip of elastomeric material to be cut.

Some of the rotary-blade cutting appliances mentioned above also use nozzles arranged near the blade surface to direct a lubricant over the blade in order to help the advancing of the blade during the cutting operation.

Unfortunately, this lubricant—in most cases an alcohol such as isopropyl alcohol, which is used to lubricate and usually also to cool the blade—represents, together with the off-cuts produced by the cutting operation, a seriously disturbing factor especially when it comes to the subsequent joining operation.

In fact, lubricants and off-cuts are a cause of poor adhesion of the elastomeric material to such an extent that, in certain prior-art embodiments, special suction devices have to be brought in alongside the abovementioned nozzles to carry away the offcuts and excess lubricant from the cutting area.

In this way, therefore, the cutting appliance, by making it necessary to clean the elastomeric material in the cutting area, inevitably becomes more complicated, a fact which generates an increase in costs not only of the appliance itself but also of the final product into which the strip or sheet of elastomeric material cut in this way is to be introduced.

In Applicant's perception the appliances known in the art for the automatic cutting of elastomeric material do not ensure a good quality of the end surfaces of the material, produced by the cutting operation, as well as a rapid and efficient execution of said operation.

In modern, highly automated processes, all the manufacturing operations are carried out automatically without the intervention of an operator who could correct, case by case, possible anomalies: in particular, as regards the joining operation, its success and the quality of execution depend directly on the uniformity and constancy of the conditions of the end surfaces of the semifinished products.

In order that the end surface possessed by the elastomeric material due to a cutting operation can be considered uniform, no discontinuities at any point along its entire transverse length—from one edge to the other of said material—have to be present: in other words it must have no depressions or protrusions forming steps that would be highly disadvantageous for example during superimposition and joining of two ends belonging to one strip of material or to two separate strips.

These discontinuities can also be created by the presence of off-cuts produced by a less than ideally executed cut, for example because of an incorrect cutting speed or owing to choosing the wrong type of blade or because of an incorrect thermal profile produced on the blade, due for example to excessive heating caused by inefficient cooling thereof.

In fact, since the material is of the elastomeric type and is in a pasty state owing to the heating effect of the blade, the off-cuts produced during the cutting operation can remain stuck to the end surface of the material creating surface irregularities which, as stated above, are highly undesirable.

To produce a material provided with uniform end surfaces also means preventing the formation of cut edges, on said end surfaces, displaying wrinkles or ripples making the elastomeric material highly unpredictable and difficult to process.

Once again, the cause of such defects may lie both in the type of blade employed, such as an unsatisfactory choice of the cutting profile of the blade, and in the faulty working conditions of the latter.

In relation to the stages when two end surfaces of the material are superimposed and joined together, it is also of fundamental importance to succeed in making the cut in such a way that the adhesive properties of the elastomeric material are preserved.

A change in its adhesive properties, due for example to a high temperature reached during the cutting phase or to the use of a lubricant that changes the physic-chemical properties of the elastomeric material being cut, will give rise to numerous problems which, as noted, will compromise the join.

A diminution of the adhesive properties of the material causes a decrease in the quality and efficiency of the production process and of the finished product into which this elastomeric material is introduced, such as a tyre for example.

With reference to the known cutting appliances mentioned above, the use of a heated-blade cutting device presents, for example, the drawback of requiring careful control of the blade temperature as this temperature must be high enough to ensure the maximum speed of cut through the elastomeric material, but at the same time not so high as to damage or actually vulcanize the still-green elastomeric material during the cutting operation.

As regards rotary-blade cutting appliances known in the art, some of the embodiments mentioned above involve the use of blades provided with a segmented cutting profile that is particularly suitable for cutting elastomeric fabrics such as those reinforced with cords.

In Applicant's perception the segmented-type blades prove unsuitable for cutting purely elastomeric material, i.e. a material of non-reinforced type, whether it is in the form of strips or of sheets, especially where this material is particularly thin.

The use, for example, of a segmented-type rotary blade on a purely elastomeric material of small thickness produces an end surface of the material characterized by unevenness and ripples that are unacceptable, especially during the joining phase.

In Applicant's perception the success of the operations applied to an elastic material following a cutting operation largely depends on the conditions under which said operation is conducted and on the type of blade used.

The Applicant has found that, in order to guarantee an excellent finish to the end surfaces of an elastomeric material when cut, without affecting the physic-chemical properties of the material, such as adhesion, and at the same time ensuring excellent speed of execution, the automatic cutting apparatus requires proper regulation of the speed of rotation of the blade in relation to its traversing speed.

Furthermore, the Applicant has also found that in order to ensure excellent speed of advance of the blade through the material during cutting without causing temperature increases in the material and without compromising, for example, adhesion, it is important to provide the cutting apparatus with a cooling unit, advantageously an air-type cooling unit, which acts in a controlled manner on the radially outermost zone of the blade.

In fact, the use of liquids for lubrication and cooling would be extremely harmful since, if were water to be employed, the water could remain trapped during the joining operation between the edges of the join and evaporate during vulcanization, producing bubbles inside the elastomeric material of the corresponding semifinished product.

If, on the other hand, oil were to be used as a liquid lubricant, this could cause an irreversible change to the physic-chemical characteristics of the elastomeric material.

The Applicant has also found that it is beneficial to provide at least one cutting surface of the blade with suitable non-stick properties, as for example by coating this surface with teflon, in order to enable the blade to advance through the elastomeric material during the cutting stage without the material sticking to the blade, which could leave the material with non-uniform end surfaces.

More specifically, the Applicant has found that this teflon-coating treatment can be carried out preferably on a first cutting surface of the blade as defined in detail in the following of the present description.

Therefore, the present invention relates to an apparatus for the automatic cutting of an element made of elastomeric material, comprising:

a rotary blade having a continuous and curvilinear cutting profile;

at least one cooling unit for cooling said blade;

a supporting structure for supporting said blade;

a feed device for moving said supporting structure transversely relative to said element;

a motor unit for spinning said blade, and

at least one structure for supporting and feeding said element to said blade,

characterized in that

the ratio of the speed of rotation of said blade to the traversing speed of said device for moving said blade is between 10 and 40;

said cooling unit conveys cold air at least onto a radially outer portion of said blade; and

at least one cutting surface possessed by said blade and interacting, during the cut, with said element of elastomeric material has non-stick properties.

Said ratio is preferably between 20 and 30.

Further features and advantages will become obvious in the light of the description of a preferred embodiment of the present invention.

This description, given below, refers to the attached drawings which are provided for explanatory purposes only and with no implication of limitation, in which:

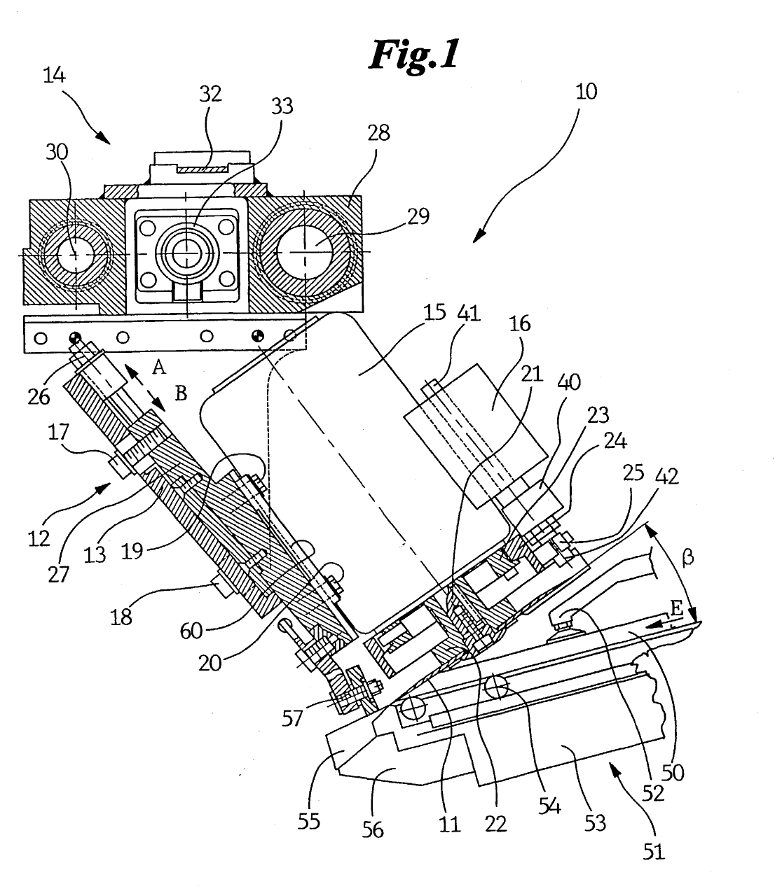

FIG. 1 is a side view, partly in section, of a cutting apparatus according to the present invention;

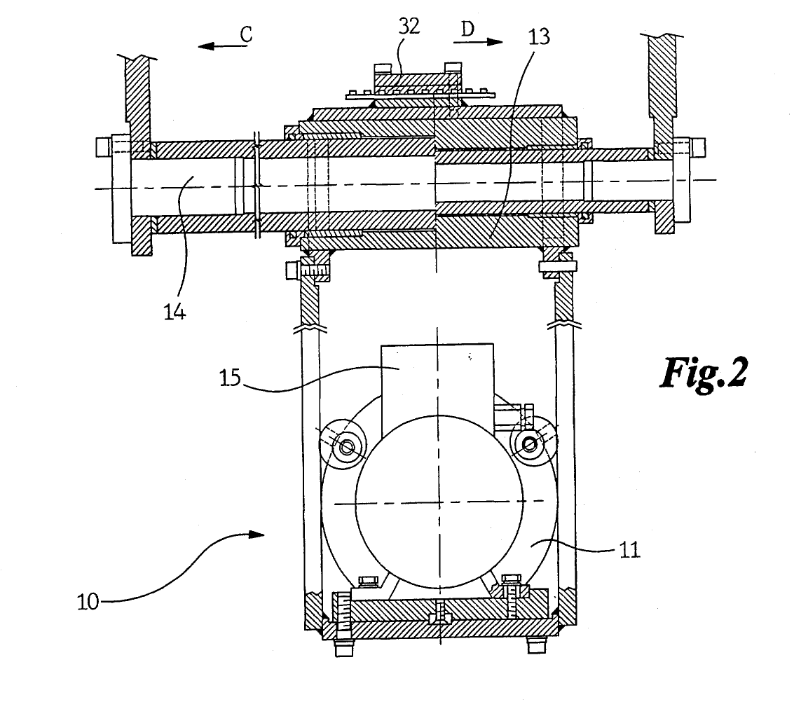

FIG. 2 is a plan view from above of the cutting apparatus illustrated in FIG. 1, and

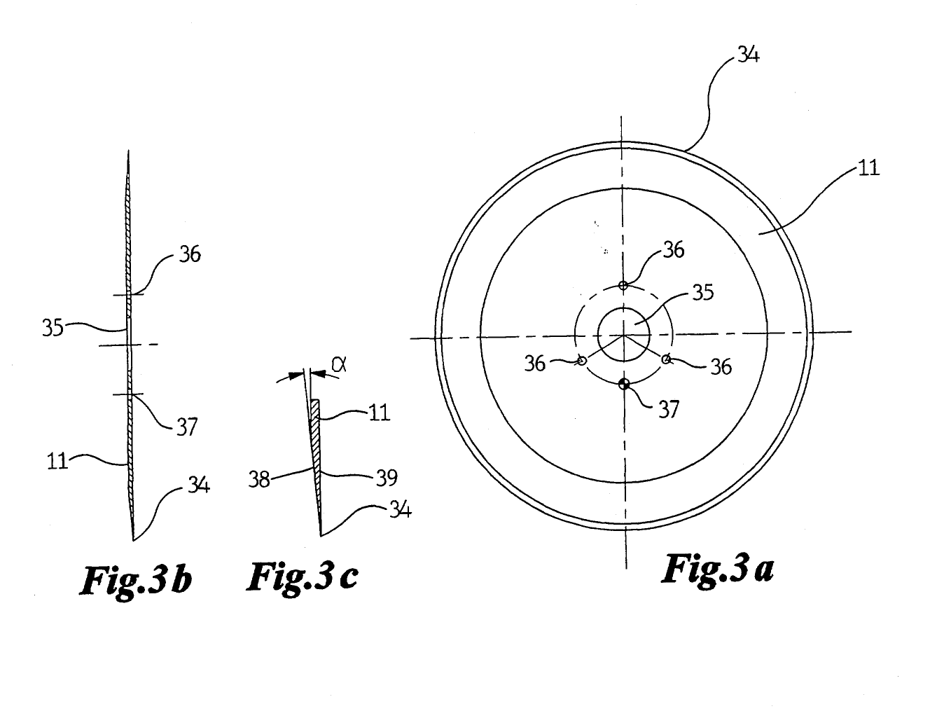

FIGS. 3a, 3b, 3c respectively show a plan view and two sectional views of the blade with which the cutting apparatus according to the present invention is provided.

FIGS. 1 and 2 show an embodiment of an apparatus 10 for the automatic cutting of elastomeric elements 50 according to the present invention.

The apparatus 10 comprises a circular blade 11 shown in detail in FIGS. 3a-3c and described later in the following of the present description. The circular blade 11 is secured to a supporting structure 12 which moves back and forth across the element 50 to be cut.

More specifically, the supporting structure 12 comprises a slide 13 on which, by means of a system of screws and bolts 17, 18, 19, 20, a motor unit 15 for spinning said blade 11 is located.

In FIG. 1, which is partly in section, it is possible to identify a rotary shaft 21 by which the motion is transmitted to the blade 11, and a bush 22 fastened to the motor unit 15 by suitable fixing devices 23, said bush 22 being the element through which the blade 11 is connected integrally to the shaft 21.

Also visible in FIG. 1 is a housing 24 that encloses the portion of the blade opposite the cutting portion, the function of this housing 24 being explained later in the following of the present description.

This supporting structure 12 also includes a cooling unit 16 of blade 11 supported by the slide 13 by means of a fixing device 25 which connects said unit 16 to said housing 24.

Said supporting structure 12 is also provided with an adjuster 26 for modifying the distance of the cutting profile or edge 34 (see FIGS. 3a-3c) of the blade 11 from the elastomeric element 50. In particular, this cutting profile 34 is advanced closer to said element 50 whenever the diameter of the blade 11 is excessively consumed by wear, for example is reduced by a distance of about 0.5 mm or more.

It is wise to monitor the degree of wear of said blade 11 so that the latter always passes fully through the elastomeric material and consequently executes the cutting operation correctly.

In further detail, said adjuster 26 usually consists of an adjusting screw, the tightening or slackening of which causes the basically frusto-conical portion 27 of the slide 13 to move in the directions of arrows A and B as indicated in FIG. 1.

The apparatus 10 of the present invention also includes a feed device 14, connected to the supporting structure 12, which moves the latter back and forth at right angles to the plane of the drawing of FIG. 1, i.e. a movement from one edge to the other of the element 50 in order to carry out the above-mentioned cutting operation.

The feed structure 14 comprises a carriage 28 to which the abovementioned supporting structure 12 is fastened, this carriage 28 being able to travel in a plane approximately parallel to the plane in which the element 50 is fed.

More specifically, this element 50 is advanced by a supporting and feed structure 51 and the movement of the carriage 28 takes place approximately parallel to said structure 51 but at a higher level.

Still more specifically, the carriage 28 moves along a pair of parallel shafts 29, 30 in the direction of arrows C and D in FIG. 2 to allow the blade 11 to cut from one edge to the other of the element 50 across the direction in which said element is fed (arrow E in FIG. 1).

The movement of the carriage 28 is provided with a belt system 32 driven by a direct-current motor (not shown in the figures) which causes the carriage 28 to execute the outward path (arrow C in FIG. 2) during the cutting operation and the return path (arrow D in FIG. 2) back to the initial position. During said return path the blade 11 is inactive.

The feed structure 14 also includes a pair of dampers 33 positioned, one on each side, at the ends of the feed path of the carriage 28, i.e. at the beginning and end of the travel of said carriage.

These dampers 33 perform the function of stopping the carriage 28 efficiently and in a correct position in the event of malfunction or failure of the carriage-feed motor.

FIGS. 3a-3c illustrate in greater detail the blade 11 used in the cutting apparatus 10 according to the present invention.

This blade 11 is a circular blade with, as indicated, a continuous cutting profile 34 that is very suitable for cutting elements 50 made of elastomeric material alone whose thickness may vary over a wide range of values, from a small value such as the thickness of a liner sheet (for example 5 mm) to a large value such as that of a tread band for a giant tyre (for example 5 cm).

Said blade 11 possesses a first hole 35 positioned centrally relative to the surface of said blade and designed to receive the shaft 21 of the motor 15 (preferably an alternating-current motor) by which the blade is turned.

The blade 11 also has second holes 36, generally numbering three, arranged equidistant from each other, close to said first hole 35, said second holes 36 performing the function of clamping the blade 11 to the abovementioned bush 22.

Lastly, a further hole 37 is provided on the surface of said blade 11 between two of the abovementioned second holes 36, this hole 37 performing the function of receiving a drive pin (not illustrated) fitted to the shaft 21 to transfer the rotary motion from the motor 16 to the blade 11.

The blade 11 illustrated in FIGS. 3a-3c has a maximum diameter of generally between 175 mm and 250 mm and a maximum thickness of approximately 10 mm. These values are selected as appropriate to the elastomeric element that is to be cut. For example, if it is the liner that is to be cut, the diameter of said blade 11 is preferably about 175 mm.

As is clearly shown in the above-mentioned figures, the radially external portion of this blade 11 presents a cutting profile or edge 34 defined by a first cutting surface 38 which tapers towards a second cutting surface 39.

More specifically, the slope of this first cutting surface 38 relative to said second cutting surface 39 defines an angle a that is preferably between 4° and 6°.

The material from which the above-mentioned blade 11 is made is preferably X200C 13 steel according to standard UNI [Italian National Standard] 3160.

In accordance with the present invention, the blade 11 is given non-stick properties such as to enable perfect execution of the cut while preventing the elastomeric material of which the element 50 is made from sticking to the cutting surfaces (particularly to the first cutting surface 38) as the blade advances and from being able to cause discontinuities on the end surfaces of the cut material.

In accordance with the present invention, said non-stick properties are preferably imparted to the abovementioned first cutting surface 38 by the fact that, during the cutting operation, the friction generated between said first surface 38 and the elastomeric element 50 is greater than the friction generated between the second cutting surface 39 and said element 50. This is mainly due to the fact that, during the cutting operation, the element 50 tends to detach itself and fall away from the above-mentioned second cutting surface 39 under its own weight.

In the embodiment illustrated, these non-stick properties are obtained by coating the first cutting surface 38 with teflon, a process whereby the blade is first sandblasted (degree SA2 to standard SIS 5000/02) to remove any oxides or residues from earlier processes from the blade surface, after which a coat of chromium primer is applied.

The blade is then baked at approximately 200-250° C. and is then given a coat of tetrafluoroethylene in aqueous dispersion.

The total thickness formed on the blade 11 is between 0.020 mm and 0.030 mm, giving the first cutting surface 38 a roughness of less than 0.8 μm (thousandths of a millimetre) and preferably less than 0.6 μm.

As an alternative to teflon coating, the first cutting surface 38 may be given a manganese phosphotization treatment or any other alternative treatment capable of giving the desired non-stick properties described above.

In accordance with the present invention, the speed of rotation of the blade produced by the motor 15 is between 900 rpm and 1400 rpm.

During the cutting operation the blade 11 has not only a predetermined speed of rotation (adjustable as a function of the type of element 50 undergoing cutting) but also a predetermined traversing speed imparted to the blade by the movement of the carriage 28 controlled by the belt system 32 described above and powered by a suitable motor (not shown). This traversing speed is between 20 m/min and 30 m/min.

In addition, the cutting apparatus according to the present invention has a peripheral speed of the blade of between 600 m/min and 800 m/min.

Therefore, in accordance with the present invention, the ratio of the speed of rotation of said blade (expressed as the abovementioned peripheral speed) to the traversing speed of said supporting structure, on which the blade is mounted, is between 10 and 40, and more preferably between 20 and 30.

As illustrated in FIG. 1, a cutting angle β is also defined between the second cutting surface 39 of the blade 11 and the surface that supports the elastomeric element 50. Generally, said cutting angle β is between 18° and 25°, and is preferably variable, increasing with the thickness of the semi-finished product to be cut. Prior to the cutting operation, depending on the type of elastomeric element to be cut, this angle may be varied by modifying the slope of the wall 60 of the roughly frusto-conical element 27 described above. In the embodiment illustrated in the figures, this slope is modified by replacing said element 27 before making the cut. In the invention, therefore, a plurality of elements 27 in which the wall 60 has different inclinations depending on the desired cutting angle β is provided.

More preferably, β is equal to 20°, at which angle the elastomeric element 50 presents an optimal end surface as this angle represents the best compromise between a limited end surface area (which is favourable in terms of friction between the cutting surface of the blade and the elastomeric element, but unfavourable when it comes to making a good join later) and a large end surface area (which is favourable in terms of excellent superimposition of the ends of the elastomeric element being joined, but highly disadvantageous in terms of friction).

As mentioned earlier in the present description, the cutting apparatus 10 according to the invention includes a cooling unit 16 for directing a stream of cold compressed air at the radially outermost portion of the blade 11.

With reference to FIG. 1, the cooling unit 16 comprises an inlet 40 through which, via suitable nozzles, a compressor (not shown because not relevant for the purposes of this invention) injects compressed air at a pressure of generally between 5 bar and 7 bar.

These nozzles inject the air at sonic velocity and, by forcing the air to follow a circular path, cause a vortex to be set up inside the unit 16 wherein the air is subjected to a high speed of rotation of the order of, for example, 10⁶ rpm.

The vortex moves inside the unit 16 and originates an adiabatic expansion—which can be controlled via a control valve 41 at the top of the unit—which produces a stream of cold air that passes through the unit 16 and reaches the outlet 42 positioned over the outer edge of the blade to be cooled.

The housing 24 referred to earlier, positioned so as to partially enclose the portion of blade opposite the cutting zone, helps to keep the cold air close to the blade 11 and so prevents its rapid dispersion into the atmosphere, which would diminish the efficiency of the cooling operation.

In accordance with the present invention, the unit 16 is operated by air at a pressure of 7 bar and at a temperature of about 21° C. Under these conditions it is possible to keep the blade operating within a temperature range of between 20° C. and 22° C. Generally, the temperature of the air is between 10° C. and 30° C. and the temperature at which the product is cut is around 24° C.-25° C., that is room temperature.

Preferably, by using a particularly cold stream of air, it is possible to cool the blade by producing a film of condensation on its surface which will behave as a lubricant that will assist the advancing of the blade into the elastomeric element. The film of condensation produced is extremely limited in volume and evaporates entirely under the heat of friction during the cutting operation. As a consequence, it is possible to prevent the problems that arise in the cooling systems of the prior art discussed above.

The structure 51 for supporting and feeding the element 50 comprises a plurality of grippers 52, such as arms fitted with suckers, which contact the element 50 and position it on a predetermined supporting element 53, technically known as the “chute”. Said element 50 is fed to the manufacturing machine by unwinding it from a storing and feeding reel or producing it in an extruder directly at the time of use.

This chute 53 has a plurality of rollers 54 to allow the element 50 to advance into contact with the cylindrical surface of a manufacturing drum (not shown) positioned downstream of the cutting apparatus 10.

The supporting and feeding structure 51 also has an underblade 55, supported by a supporting element 56, which acts in conjunction with the above-mentioned blade 11.

In more detail, in order to perform the cutting operation properly, the supporting structure 12 also includes a rolling and pressing device 57 consisting of one or more rollers which, being positioned close to the zone of incision of the blade 11, keep the element 50 in position by exerting pressure on the abovementioned underblade 55 as the carriage 28, to which they are integrally fixed, moves along.

In this way the blade 11 produces an excellent cut as it advances without running the risk of exerting disturbing forces on the element 50, which could impair its correct positioning with respect to the blade and on the drum.

The pressure exerted by said rollers may be predetermined and adjusted by means of one or more tensioning elements (not shown), such as springs.

The cutting operation carried out by the cutting apparatus according to the present invention therefore involves the following phases.

With one end of the elastomeric element 50 positioned on the manufacturing drum in the manner described above, by means of the above-mentioned supporting and feeding structure 51, the carriage 28 is in position at the start of its stroke and the blade 11 is located over the first edge of said element 50 which is to be cut.

A few moments before the motor 15 starts to spin the blade 11, the cooling unit 16 is started in order to cool the blade and release onto it the film of condensation referred to above, which acts, as indicated, as both coolant and lubricant during the cutting phase.

After a few moments, the carriage 28 is traversed horizontally (arrow C) and initiates the cut which finishes when the blade leaves the opposite edge (the second edge) of said element 50.

When the carriage reaches the end of its stroke the rotation of the blade is stopped and the cooling unit turned off, while the carriage 28 is moved back in the opposite direction (arrow D) to regain the earlier starting position, ready for the next cutting operation on the next elastomeric element which will be fed to the manufacturing drum.

The cutting apparatus according to the present invention therefore makes it possible to give the elastomeric element subjected to this operation an end surface, produced by the cut, that is perfectly continuous and free of wrinkles, unevenness and offcuts which, as stated, are the cause of serious problems in the subsequent processing of the element, particularly at the joining stage.

The cutting apparatus according to the invention ensures that the adhesive abilities of the elastomeric element are unaffected, maintains the temperature of the cutting blade at a constant value and avoids the production of off-cuts, thus giving significant advantages including safeguarding the properties initially possessed by the starting composition of said elastomeric element.

The cutting operation is therefore carried out in such a way as both to ensure excellent product quality and to perform the operation very fast, much to the advantage of the productivity of the process where the cutting apparatus according to the invention is applied.

As already noted, the cutting operation performed with an appliance according to the present invention can be carried out not only during the process of manufacturing a tyre but also in any other process where elements made of elastomeric material only are required to be cut automatically.

Although the specific peculiarities of the different elastomeric elements to be cut inevitably influence their cutting, the technical characteristics and modes of operation of the cutting device according to the present invention ensure that the cut is excellent whatever the geometrical dimensions and the characteristics of composition of the elastomeric element which is put through this operation.

1. Apparatus (10) for the automatic cutting of an element (50) made of elastomeric material, comprising:
a rotary blade (11) having a continuous and curvilinear cutting profile (34);
at least one cooling unit (16) for cooling said blade (11);
a supporting structure (12) for supporting said blade (11);
a feed device (14) for moving said supporting structure (12) transversely (C, D) relative to said element (50);
a motor unit (15) for spinning said blade (11), and
at least one structure (51) for supporting and moving said element (50) to said-blade (11),
characterized in that
the ratio of the speed of rotation of said blade (11) to the traversing speed of said feed device (14) is between 10 and 40;
said cooling unit (16) conveys cold air at least onto a radially outer portion of said blade (11); and
at least one cutting surface (38) possessed by said blade (11) and interacting, during the cut, with said element (50) of elastomeric material has non-stick properties.

2. Apparatus (10) according to claim 1, characterized in that said ratio is between 20 and 30.

3. Apparatus (10) according to claim 1 or 2, characterized in that said blade (11) has a speed of rotation of between 900 rpm and 1400 rpm.

4. Apparatus (10) according to any one of the preceding claims, characterized in that the traversing speed of said feed structure (14) is between 20 m/min and 30 m/min.

5. Apparatus (10) according to any one of the preceding claims, characterized in that said blade (11) has a peripheral speed of between 600 m/min and 800 m/min.

6. Apparatus (10) according to any one of the preceding claims, characterized in that said blade (11) has a cutting edge (34) between a first cutting surface (38) and a second cutting surface (39).

7. Apparatus (10) according to claim 6, characterized in that in a peripheral portion of said blade (11) said first cutting surface (38) is in a sloping position converging radially towards said second cutting surface (39).

8. Apparatus (10) according to claim 7, characterized in that the slope (α) of said first cutting surface (38) is between 4° and 6° with respect to said second cutting surface (39).

9. Apparatus. (10) according to claim 6, characterized in that said at least a cutting surface possessed by said blade (11) and interacting, during the cut, with said element (50) of elastomeric material is represented by said first cutting surface (38).

10. Apparatus (10) according to claim 6, characterized in that said first cutting surface (38) is teflon-coated.

11. Apparatus (10) according to any one of the preceding claims, characterized in that the angle (β) between said second cutting surface (39) and said elastomeric element (50) is between 18° and 25°.

12. Apparatus (10) according to any one of the preceding claims, characterized in that said cooling unit (16) is supplied with air at a pressure of between 5 bar and 7 bar.

13. Apparatus (10) according to claim 11, characterized in that said air is at a temperature of between 10° C. and 30° C.

14. Apparatus (10) according to any one of the preceding claims, characterized in that said supporting structure (12) of said blade (11) is provided with a device (57) for rolling and pressing said elastomeric element (50) during the cut.
